(19) United States
(12) Patent Application Publication
(10) Pub. No.: US 2022/0184920 A1
(43) Pub. Date: Jun. 16, 2022

(54) DISPLAY DEVICE

(71) Applicant: Wuhan China Star Optoelectronics Semiconductor Display technology Co., Ltd., Wuhan, Hubei (CN)

(72) Inventors: Chengjie JIA, Wuhan, Hubei (CN); Hong GAO, Wuhan, Hubei (CN)

(73) Assignee: Wuhan China Star Optoelectronics Semiconductor Display Technology Co., Ltd., Wuhan, Hubei (CN)

(21) Appl. No.: 17/254,329

(22) PCT Filed: Jul. 22, 2020
(86) PCT No.: PCT/CN2020/103493

§ 371 Date: Dec. 21, 2020

(30) Foreign Application Priority Data
Jun. 19, 2020 (CN) 202010566142.X

(51) Int. Cl. B32B 5/18; B32B 27/06; G02F 1/1333

(52) U.S. Cl. CPC B32B 5/18; B32B 27/065; G02F 1/133314; B32B 2250/03; B32B 2266/104; B32B 2307/42; B32B 2266/06; B32B 2266/08; B32B 2457/20

(57) ABSTRACT

A display device is disclosed, including: a back plate, a display module disposed on a side of the back plate, a cover plate disposed on a side of the display module away from the back plate, and a buffer layer disposed on a side of the back plate away from the cover plate. Wherein, the buffer layer includes at least one of at least one first sub-buffer layer, at least one second sub-buffer layer, and at least one third sub-buffer layer. The first sub-buffer layer is made of a foamed material with a completely closed hole structure, the second sub-buffer layer is made of a foamed material with a half-open and half-closed hole structure, and the third sub-buffer layer is made of a foamed material with a completely open hole structure.

### CROSS REFERENCE TO RELATED APPLICATIONS

The present disclosure claims priority from a Chinese patent application filed with the National Intellectual Property Administration on Jun. 19, 2020, with application number 202010566142.X, and titled “DISPLAY DEVICE”, which is incorporated by reference in the present application in its entirety.

### FIELD OF INVENTION

The present disclosure relates to the field of display technologies, and particularly relates to a display device.

### BACKGROUND OF INVENTION

With more and more models of foldable mobile phones, foldable mobile phones have not been quickly promoted to enter mass market due to obvious defects and lack of good solutions. Please refer to FIG. 1 for a structure of a general foldable screen. FIG. 1 is a schematic diagram of a structure of a display device in the prior art. In the prior art, the display device includes a buffer layer 100, a back plate 102, and a cover plate 103 disposed on a side of the back plate 102 far away from the buffer layer 100. The display device further includes the cover plate 103, a first adhesive layer 104, a polarizer layer 105, a touch layer 106, a second adhesive layer 107, and a display substrate 108 disposed from top to bottom, and the display substrate 108 is disposed on the back plate 102, and the cover plate 103 is a light emitting side. Existing foldable screens have defects such as surface hardness, falling ball, falling pen, crease, screen gap, and so on.

Therefore, in order to improve impact resistance of the display device and ensure products pass falling ball test successfully, so as to achieve a purpose of improving product yield, it is now necessary to provide a display device.

### Technical Problems

The present disclosure provides a display device. A buffer layer is disposed on a side of a back plate away from a cover plate. The buffer layer includes at least one of at least one first sub-buffer layer, at least one second sub-buffer layer, and at least one third sub-buffer layer. The first sub-buffer layer is made of a foamed material with a completely closed hole structure, the second sub-buffer layer is made of a foamed material with a half-open and half-closed hole structure, and the third sub-buffer layer is made of a foamed material with a completely open hole structure, which can improve point impact resistance of falling pen test.

### Technical Solutions

In a first aspect, an embodiment of the present disclosure provides a display device, including: a back plate, a display module disposed on a side of the back plate, a cover plate disposed on a side of the display module away from the back plate, and a buffer layer disposed on a side of the back plate away from the cover plate. Wherein, the buffer layer includes at least one of at least one first sub-buffer layer, at least one second sub-buffer layer, and at least one third sub-buffer layer, and the first sub-buffer layer is made of a foamed material with a completely closed hole structure, the second sub-buffer layer is made of a foamed material with a half-open and half-closed hole structure, and the third sub-buffer layer is made of a foamed material with a completely open hole structure.

In some embodiments, the buffer layer includes at least one first sub-buffer layer and at least one second sub-buffer layer, the second sub-buffer layer is disposed on a side of the first sub-buffer layer away from the back plate.

In some embodiments, the buffer layer includes at least one first sub-buffer layer and at least one third sub-buffer layer, the third sub-buffer layer is disposed on a side of the second sub-buffer layer away from the back plate.

In some embodiments, the buffer layer includes at least one first sub-buffer layer, at least one second sub-buffer layer, and at least one third sub-buffer layer, wherein the second sub-buffer layer is disposed on a side of the first sub-buffer layer away from the back plate, and the third sub-buffer layer is disposed on a side of the second sub-buffer layer away from the first sub-buffer layer.

In a second aspect, an embodiment of the present disclosure further provides a display device, wherein, the display device includes: a back plate, a display module disposed on one side of the back plate, a cover plate disposed on a side of the display module away from the back plate, and a buffer layer disposed on a side of the back plate away from the cover plate. Wherein, the buffer layer comprises at least one first sub-buffer layer, and the first sub-buffer layer is made of a foamed material with a completely closed hole structure.

In some embodiments, the buffer layer further includes at least one second sub-buffer layer, the second sub-buffer layer is disposed on a side of the first sub-buffer layer away from the back plate, and the second sub-buffer layer is made of a foamed material with a half-open and half-closed hole structure.

In some embodiments, the buffer layer further includes at least one third sub-buffer layer, and the third sub-buffer layer is made of a foamed material with a completely open hole structure.

In some embodiments, the third sub-buffer layer is disposed on a side of the first sub-buffer layer away from the back plate.

In some embodiments, the third sub-buffer layer is disposed on a side of the second sub-buffer layer away from the first sub-buffer layer.

In some embodiments, a buffer rate of the first sub-buffer layer ranges from 12.76% to 16.84%.

In some embodiments, a buffer rate of the second sub-buffer layer ranges from 2.61% to 9.11%.

In some embodiments, a buffer rate of the third sub-buffer layer ranges from 1.53% to 1.95%.

In some embodiments, a bore diameter of the half-open and half-closed hole structure ranges from 20 μm to 50 μm.

In some embodiments, a bore diameter of the completely open hole structure ranges from 70 μm to 110 μm.

### Beneficial Effects

Advantages of the present disclosure are: a buffer layer is disposed on a side of a back plate away from a cover plate in the display device described in the present disclosure, the buffer layer includes at least one of at least one first sub-buffer layer, at least one second sub-buffer layer, and at least one third sub-buffer layer, the first sub-buffer layer is made of a foamed material with a completely closed hole structure, the second sub-buffer layer is made of a foamed material with a half-open and half-closed hole structure, and the third sub-buffer layer is made of a foamed material with a completely open hole structure, which can improve point impact resistance of falling pen test. When performing a falling ball test on the display device, the buffer layer can have a certain buffer effect on an impact force of the falling ball test. Therefore, it can improve the impact resistance of the display device and ensure the display device passing falling ball test successfully, thereby improving a yield of the display device.

### DESCRIPTION OF DRAWINGS

FIG. 1 is a structural schematic view of a display device in the prior art.

FIG. 2 is a structural schematic view of a display device provided in an embodiment of the present disclosure.

FIG. 3 is a structural schematic view of a display device provided in another embodiment of the present disclosure.

FIG. 4 is a structural schematic view of a display device provided in other embodiments of the present disclosure.

FIG. 5 is a structural schematic view of a foamed material with a completely closed hole structure provided in the present disclosure.

FIG. 6 is a structural schematic view of a foamed material with a half-open and half-closed hole structure provided in the present disclosure.

FIG. 7 is a structural schematic view of a foamed material with a completely open hole structure provided in the present disclosure.

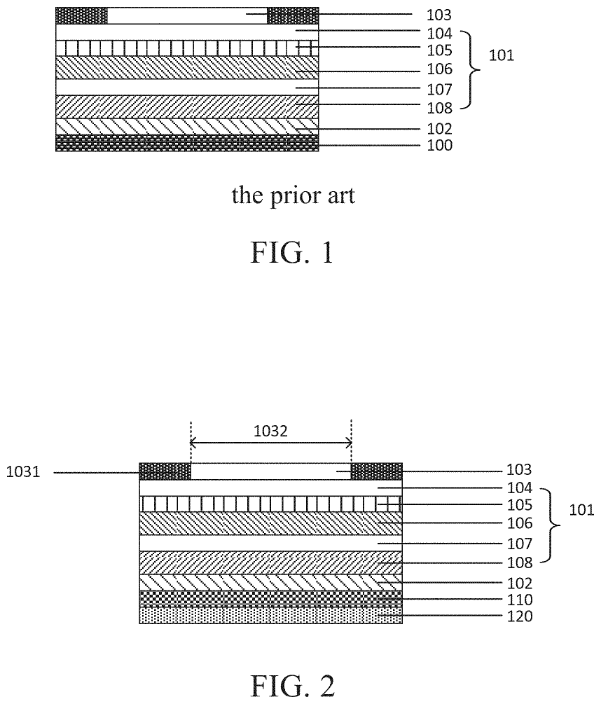

### DETAILED DESCRIPTION OF EMBODIMENTS

The present disclosure provides a display device. To make the objectives, technical solutions, and effects of the present disclosure clearer, the present disclosure is further described in detail below with reference to the embodiments accompanying with drawings. It should be understood that specific embodiments described herein are merely for explaining the present disclosure, and the present disclosure is not limited thereto.

Specifically, referring to FIG. 2, it is a structural schematic view of a display device provided in an embodiment of the present disclosure. In the embodiment, a display device is provided, which is suitable for flexible display. As shown in FIG. 2, the display device includes a back plate 102, a display module 101 disposed on a side of the back plate 102, a cover plate 103 disposed on a side of the display module 101 away from the back plate 102, and a buffer layer disposed on a side of the back plate 102 away from the cover plate 103. Wherein, a side of the cover plate 103 away from the back plate 102 refers to a light emitting surface, and the buffer layer includes at least one first sub-buffer layer 110, and the first sub-buffer layer 110 is made of a foamed material with a completely closed hole structure. Wherein, the display module 101 includes a polarizer layer 105, a touch layer 106, and a display panel 108 sequentially disposed from top to bottom, and the display module 101 further includes a first adhesive layer 104 disposed between the polarizer layer 105 and the cover plate 103 and a second adhesive layer 107 disposed between the display panel 108 and the touch layer 106.

In the present disclosure, a preferred material of the buffer layer is foam. Wherein, the greater a hardness of the foam is, the better a buffer rate of the buffer layer is. In addition, factors affecting the buffer rate of the foam include density, type of hole structure, and material ratio. In some embodiments, the material of the buffer layer is selected from at least one of chemical crosslinked polyethylene (XPE) foam or expandable polyethylene (EPE) pearl cotton. In other embodiments, the material of the buffer layer includes but is not limited to the foam and other soft porous materials.

In the present disclosure, the buffer layer may be made of foam with any one type of three different types of holes including a completely open hole structure, a completely closed hole structure, and a half-open and half-closed hole structure. A compression ratio and the hardness of the foam with different types of holes are different, and thus impact absorption capacity of the different types of holes are different. Wherein, the compression ratio of the foam refers to a ratio of a thickness of a compressed part of the foam to an original thickness of the foam. The greater the compression ratio of the foam is, the softer the foam is. Specifically, the compression ratio of the foam with the completely closed hole structure is less than that of the foam with the half-open and half-closed hole structure, and the compression ratio of the foam with the half-open and half-closed hole structure is less than that of the foam with the completely open hole structure. Conversely, the hardness of the foam with the completely closed hole structure is greater than that of the foam with the half-open and half-closed hole structure, and the hardness of the foam with the half-open and half-closed hole structure is less than that of the foam with the completely open hole structure.

In the present disclosure, as a preferred embodiment, a buffer rate of the first sub-buffer layer 110 ranges from 12.76% to 16.84%. Furthermore, the buffer rate of the first sub-buffer layer 110 may be preferably but not limited to at least one of 16.84%, 16.75%, or 12.76%.

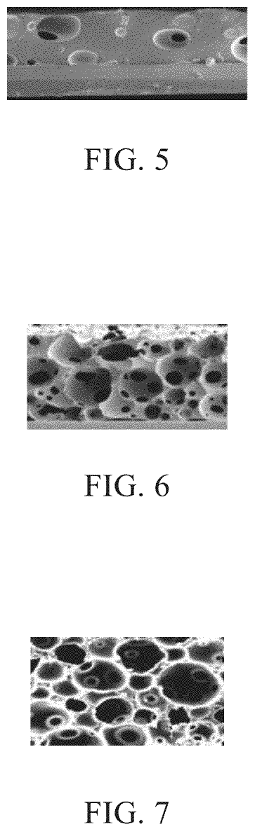

Referring to FIG. 5, it is a structural schematic view of a foamed material with a completely closed hole structure provided in the present disclosure. As shown in FIG. 5, because the first sub-buffer layer 110 is made of the foamed material with the completely closed hole structure, the buffer rate of the first sub-buffer layer 110 is higher, that is, the impact resistance of the first sub-buffer layer 110 is better.

Sequentially referring to FIG. 2, in a preferred embodiment of the present disclosure, the buffer layer further includes at least one second sub-buffer layer 120, that is, the buffer layer is a porous structural component which includes two stacked layers, and the porous structure component is made of a foamed material with different types of holes. As shown in FIG. 2, in a preferred embodiment, the buffer layer includes a first sub-buffer layer 110 and a second sub-buffer layer 120. The second sub-buffer layer 120 is disposed on a side of the first sub-buffer layer 110 away from the back plate 102, and the first sub-buffer layer 110 is made of a foamed material with a completely closed hole structure, and the second sub-buffer layer 120 is made of a foamed material with a half-open and half-closed hole structure.

In the preferred embodiment, a buffer rate of the second sub-buffer layer 120 ranges from 2.61% to 9.11%. Furthermore, the buffer rate of the second sub-buffer layer 120 may be preferably but not limited to at least one of 9.11%, 3.71%, or 2.61%.

Referring to FIG. 6, it is a structural schematic view of a foamed material with a half-open and half-closed hole structure provided in the present disclosure. In the embodiment, as shown in FIG. 6, a bore diameter of the half-open and half-closed hole structure ranges from 20 μm to 50 μm.

In the embodiment, due to the compression ratio of the foamed material with the half-open and half-closed hole structure being greater than that of the foam with the completely closed hole structure, that is, the hardness of the first sub-buffer layer 110 is greater than that of the second sub-buffer layer 120, the buffer rate of the first sub-buffer layer 110 is better than that of the second sub-buffer layer 120. That is, the buffer rate of the first sub-buffer layer 110 with the completely closed hole structure is greater than that of the second sub-buffer layer 120 with the half-open and half-closed hole structure. Therefore, on the basis of good buffer rate of the first sub-buffer layer 110, the second sub-buffer layer 120 has a function of further improving the impact resistance of the buffer layer.

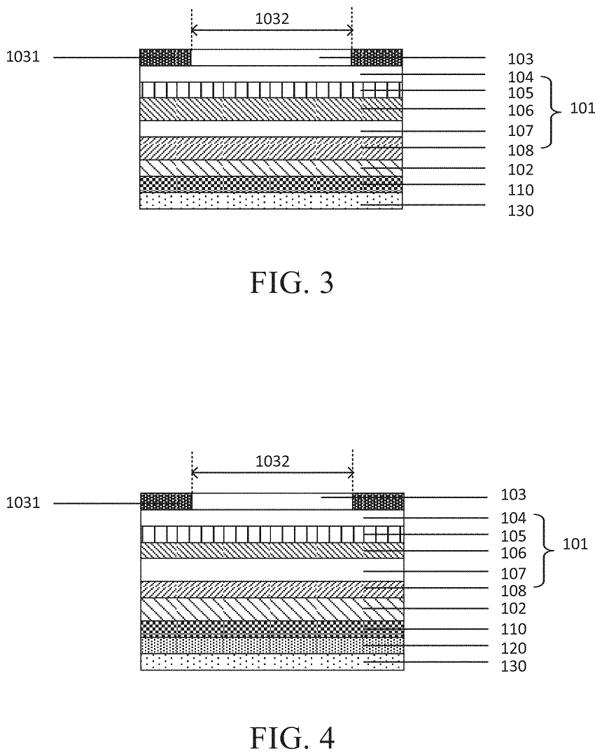

Referring to FIG. 3, it is a structural schematic view of a display device provided in another embodiment of the present disclosure. In the embodiment, the difference from the embodiment shown in FIG. 2 is that the buffer layer further includes at least one third sub-buffer layer 130. The third sub-buffer layer 130 is made of the foamed material with the completely open hole structure.

As shown in FIG. 3, in a preferred embodiment, the buffer layer includes a first sub-buffer layer 110 and a third sub-buffer layer 130. The third sub-buffer layer 130 is disposed on a side of the first sub-buffer layer 110 away from the back plate 102.

In some embodiment, a buffer rate of the third sub-buffer layer 130 ranges from 1.53% to 1.95%. Furthermore, the buffer rate of the third sub-buffer layer 130 may be preferably but not limited to at least one of 1.95%, 1.53%, 0.97%, 0.79%, or 0.41%.

Referring to FIG. 7, it is a structural schematic view of a foamed material with a completely open hole structure provided in the present disclosure. In some embodiment, As shown in FIG. 7, a bore diameter of the completely open hole structure ranges from 70 μm to 110 μm.

In the embodiment, when the third sub-buffer layer 130 is made of the foamed material with a completely open hole structure, the hardness of the first sub-buffer layer 110 is greater than that of the third sub-buffer layer 130, so that the buffer rate of the first sub-buffer layer 110 is greater than that of the third sub-buffer layer 130 in the embodiment. Therefore, on the basis of better buffer performance and better impact resistance of the first sub-buffer layer 110, the third sub-buffer layer 130 has a function of further improving the buffer performance of the buffer layer.

In the embodiment, the third sub-buffer layer 130 made of the foamed material with the completely open hole structure is configured to replace the second sub-buffer layer 120 made of the foamed material with the half-open and half-closed hole structure in the previous embodiment. Because in most cases, the hardness of the foamed material with the half-open and half-closed hole structure is greater than that of the foamed material with the completely open hole structure, and the greater the hardness is, the higher the price of the foamed material is. Therefore, on the basis of realizing that the buffer layer has a good buffering effect, the preferred embodiment can further save costs to a certain extent.

Referring to FIG. 4, it is a structural schematic view of a display device provided in other embodiment of the present disclosure. In another preferred embodiment, the buffer layer is a porous structural component which includes stacked three layers. Specifically, as shown in FIG. 4, the buffer layer includes a first sub-buffer layer 110, a second sub-buffer layer 120, and a third sub-buffer layer 130. The second sub-buffer layer 120 is disposed on a side of the first sub-buffer layer 110 away from the back plate 102, and the third sub-buffer layer 130 is disposed on a side of the second sub-buffer layer 120 away from the first sub-buffer layer 110. Wherein, the first sub-buffer layer 110 is made of a foamed material with a completely closed hole structure, the second sub-buffer layer 120 is made of a foamed material with a half-open and half-closed hole structure, and the third sub-buffer layer 130 is made of a foamed material with a completely open hole structure.

In the above-mentioned embodiment of the disclosure, the first sub-buffer layer 110 mainly serves as a buffering role, and the second sub-buffer layer 120 and the third sub-buffer layer 103 are equivalent to forming a structure for preventing an impact force absorption layer. So the embodiment has better buffer performance and better impact resistance, which can further enhance the impact resistance of the display panel 108.

In the above embodiments of the present disclosure, the buffer layer is configured to buffer damage to the display panel 108 when the display device is under external impact, which can effectively protect the display device, and the buffer layer can also be configured to improve resistance to point impact of the falling pen test.

In the present disclosure, the back plate 102 and the first sub-buffer layer 110 are bonded together by an adhesive.

In the present disclosure, the back plate 102 needs to have good thermal conductivity, and the material of the back plate 102 includes but is not limited to any one of polyimide (PI) materials, polyethylene terephthalate (PET) materials, nylon, and other plastic materials. The material of the back plate 102 may also include a mixture of metal copper foil, graphite heat sink, and at least two of the above plastic materials.

In the present disclosure, the display device further includes a frame (not shown), and the frame and the back plate 102 are integrally connected or assembled. The frame is disposed around the back plate 102 and defines an accommodation space (not shown) with the back plate 102, and the accommodation space is configured to accommodate the display panel 108.

In the present disclosure, the display panel 108 can emit light by using liquid crystal technology, organic light-emitting technology, and electroluminescence technology, etc. The display panel 108 may be an organic light-emitting diode (OLED) display panel, a liquid crystal display panel, and light-emitting diode (LED), etc. For example, when the display panel 108 is an OLED display panel, the display panel 108 includes a thin film transistor array substrate, the touch layer 106 may be an on-cell structure, and the touch layer 106 is disposed on the thin film transistor array substrate of the display panel 108. The touch layer 106 is connected to the thin film transistor array substrate of the display panel 108, and the thin film transistor array substrate includes a thin film transistor array layer, an OLED light-emitting layer, and a thin film package layer in turn. The OLED light-emitting layer includes an anode, a hole injection layer, a hole transport layer, an organic light-emitting layer, an electron transport layer, an electron injection layer, and a cathode formed in turn above the thin film transistor array layer. And the thin film package layer covers the OLED light-emitting layer. In addition, in other embodiments, when the display panel 108 is an OLED display panel, the touch layer 106 may also is an in-cell structure, and a position of the touch layer 106 is replaced by interior of the thin film transistor array substrate embedded in the OLED display panel.

In the disclosure, when the display panel 108 is a liquid crystal display panel, the display module further includes a backlight source and an optical film. The backlight source is an LED, and the optical film includes a light guide plate, a reflection film, a diffusion plate, a brightness enhancement film, and a double-sided adhesive tape, etc. The optical film is disposed on a side of the back plate 102 away from the display panel 108.

In the present disclosure, when the display panel 108 is a liquid crystal display (LCD) panel, the display module 101 further includes the polarizer layer 105 (POL, Polarizing Film). The polarizer layer 105 is configured to convert non-polarized natural light into polarized light, and to control whether or not light passes through by utilizing torsion characteristics of liquid crystal molecules, which makes the liquid crystal display panel display images normally.

In the disclosure, the cover plate 103 (or a cover plate module) is a glass cover plate or a 3D cover plate, and an outer diameter of the cover plate 103 is greater than an outer diameter of the display panel 108. A side of the cover plate 103 away from the display panel 108 is an arc surface, and the arc surface includes an arc chamfer. The cover plate 103 may be processed and shaped by hot bending process, which can make the appearance of the display device beautiful and smooth, and make the visual effect significantly better.

As shown in FIG. 2, the first adhesive layer 104 is configured to fix and bond the cover plate 103 and the polarizer layer 105, and the second adhesive layer 107 is configured to fix and bond the touch layer 106 and the display panel 108. In the embodiment, the first adhesive layer 104 and the second adhesive layer 107 both are optically clear adhesive (OCA).

In other embodiments, the first adhesive layer 104 and the second adhesive layer 107 may further include but are not limited to at least one of OCA or water adhesive. Wherein, the water adhesive is configured to reduce reflection at the interface, suppress a light leakage at the splicing place, and enhance a light transmission ability of the display module.

In some embodiments, the display panel 108 further includes a light-transmitting area 1032, and an open hole (not shown) is defined in the polarizer layer 105 corresponding to the light-transmitting area 1302, and the open hole is filled with the OCA or the water adhesive. The OCA in the open hole is configured to make the cover plate 103, the first adhesive layer 104, and the polarizer layer 105 closely adhere to each other to prevent the formation of an air layer at the open hole, thereby preventing a phenomenon of full emission of some light rays at the open hole.

Please sequentially refer to FIG. 2. The cover plate 103 is a light-transmitting cover plate, and at least one ink area 1031 is disposed on the cover plate 103. The ink area 1031 is corresponding to the light-transmitting area 1032 of the display module. A through hole or a blind hole is disposed in the light-transmitting area 1032 along a thickness direction of the display panel, the ink area 1031 is configured to shield edges of the through hole or the blind hole. The ink area 1031 may effectively improve product production yield and further improve product production efficiency.

The present disclosure further provides a display device, which includes the display components as described above, and further includes optical components such as a camera. And the camera is corresponding to the blind hole or the through hole area of the light-transmitting area 1032.

During performing the falling ball test on the display module described in the disclosure, when a solid steel plate is used in the test, a bright spot is present at a falling pen height of 1.5 cm, and when a lower part of the steel plate is avoided, a bright spot is present at a falling pen height of 11 cm.

For specific implementation of the foregoing operations, refer to the foregoing embodiments. Details are not further described herein.

In summary, the display device provided by the disclosure, the buffer layer is disposed on a side of a back plate 102 away from a cover plate 103. The buffer layer includes at least one of at least one first sub-buffer layer 110, at least one second sub-buffer layer 120, and at least one third sub-buffer layer 130. The first sub-buffer layer 110 is made of a foamed material with a completely closed hole structure, the second sub-buffer layer 120 is made of a foamed material with a half-open and half-closed hole structure, and the third sub-buffer layer 130 is made of a foamed material with a completely open hole structure to improve point impact resistance of falling pen test. When performing the falling ball test on the display device, the buffer layer can buffer an impact force of falling ball test to a certain extent. Therefore, it can improve the impact resistance of the display device and ensure the display device passing falling ball test successfully, thereby improving the yield of the display device.

It can be understood that, for those skilled in the art, equivalent replacements and modifications can be made according to the technical solution and disclosure ideas thereof of the present disclosure, and all these modifications or replacements are considered within the protection scope of the attached claims of the present disclosure.

What is claimed is:

1. A display device, comprising:
a back plate;
a display module disposed on a side of the back plate;
a cover plate disposed on a side of the display module away from the back plate; and,
a buffer layer disposed on a side of the back plate away from the cover plate;
wherein the buffer layer comprises at least one of at least one first sub-buffer layer, at least one second sub-buffer layer, and at least one third sub-buffer layer, and the first sub-buffer layer is made of a foamed material with a completely closed hole structure, the second sub-buffer layer is made of a foamed material with a half-open and half-closed hole structure, and the third sub-buffer layer is made of a foamed material with a completely open hole structure.

2. The display device in claim 1, wherein the buffer layer comprises the at least one first sub-buffer layer and the at least one second sub-buffer layer, and the second sub-buffer layer is disposed on a side of the first sub-buffer layer away from the back plate.

3. The display device in claim 1, wherein the buffer layer comprises the at least one first sub-buffer layer and the at least one third sub-buffer layer, and the third sub-buffer layer is disposed on a side of the second sub-buffer layer away from the back plate.

4. The display device in claim 1, wherein the buffer layer comprises the at least one first sub-buffer layer, the at least one second sub-buffer layer, and the at least one third sub-buffer layer, wherein the second sub-buffer layer is disposed on a side of the first sub-buffer layer away from the back plate, and the third sub-buffer layer is disposed on a side of the second sub-buffer layer away from the first sub-buffer layer.

5. A display device, comprising:
a back plate;
a display module disposed on one side of the back plate;
a cover plate disposed on a side of the display module away from the back plate; and,
a buffer layer disposed on a side of the back plate away from the cover plate;
wherein the buffer layer comprises at least one first sub-buffer layer, and the first sub-buffer layer is made of a foamed material with a completely closed hole structure.

6. The display device in claim 5, wherein the buffer layer further comprises at least one second sub-buffer layer, the second sub-buffer layer is disposed on a side of the first sub-buffer layer away from the back plate, and the second sub-buffer layer is made of a foamed material with a half-open and half-closed hole structure.

7. The display device in claim 6, wherein the buffer layer further comprises at least one third sub-buffer layer, and the third sub-buffer layer is made of a foamed material with a completely open hole structure.

8. The display device in claim 7, wherein the third sub-buffer layer is disposed on the side of the first sub-buffer layer away from the back plate.

9. The display device in claim 7, wherein the third sub-buffer layer is disposed on a side of the second sub-buffer layer away from the first sub-buffer layer.

10. The display device in claim 5, wherein a buffer rate of the first sub-buffer layer ranges from 12.76% to 16.84%.

11. The display device in claim 6, wherein a buffer rate of the second sub-buffer layer ranges from 2.61% to 9.11%.

12. The display device in claim 7, wherein a buffer rate of the third sub-buffer layer ranges from 1.53% to 1.95%.

13. The display device in claim 11, wherein a bore diameter of the half-open and half-closed hole structure ranges from 20 μm to 50 μm.

14. The display device in claim 12, wherein a bore diameter of the completely open hole structure ranges from 70 μm to 110 μm.
